(19) United States
(12) Patent Application Publication
(10) Pub. No.: US 2015/0167906 A1
(43) Pub. Date: Jun. 18, 2015

(54) LIGHT SOURCE UNIT, PROJECTION-TYPE DISPLAY DEVICE, LIGHTING EQUIPMENT AND LIGHT EMISSION METHOD

(71) Applicant: NEC cORPORATIN, Tokyo (JP)

(72) Inventors: Mizuho Tomiyama, Tokyo (JP); Naofumi Suzuki, Tokyo (JP)

(73) Assignee: NEC Corporatin, Tokyo (JP)

(21) Appl. No.: 14/406,819

(22) PCT Filed: Dec. 13, 2012
(86) PCT No.: PCT/JP2012/082354

§ 371 Date: Dec. 10, 2014

(30) Foreign Application Priority Data
Jun. 11, 2012 (JP) 2012-131836

(51) Int. Cl. F21K 99/00; F21V 13/08; F21V 9/14; G03B 21/20; F21V 9/16

(52) U.S. Cl. CPC F21K 9/56; G03B 21/204; F21V 9/16; F21V 9/14; F21V 13/08

(57) ABSTRACT

A light source unit includes a light emission unit, a wavelength conversion unit and a first wavelength selection, unit. The light emission unit has a light emission surface which emits light of a first wavelength band and reflects incident light. The wavelength conversion unit has an incidence/emission surface which, when light of the first, wavelength band is incident on it, emits light of a second wavelength band toward the same side as that of the incidence of the light, of the first wavelength band and reflects light of the second wavelength band re-incident on it. The first wavelength selection unit has a first reflection surface which reflects light, of the first wavelength band and transmits light of the second wavelength band. Light from the light emission surface, light, reflected by the first reflection surface, and light reflected by the light emission surface become incident on the incidence/emission surface.

### TECHNICAL FIELD

The present invention relates to a light source unit, a projection-type display device, lighting equipment and a light emission method.

### BACKGROUND ART

For a projection-type display device such as a projector and for lighting equipment and the like, demanded is a light source unit with high brightness, low power consumption and long life. At present, light source units employing a light emitting diode (LED) or a semiconductor laser (LD) have been proposed as those which meet the demand. These LED and LD are fabricated using semiconductors, and it is known that blue light can be generated by using InGaN-based semiconductor materials, and red light by using AlGalnP-based semiconductor materials. However, such LEDs and LDs employing InGaN-based or AlGalnP-based semiconductor materials have a problem of low efficiency in green light, emission, which is referred to as a the green gap. As a means for solving this problem, a light source unit employing an LED or an LD in combination with a phosphor has been proposed.

For example, PTL (patent literature) 1 describes a high-output light source unit in which self-heat generation of a phosphor is suppressed. The light source unit comprises a light emission means and a wavelength conversion means including a phosphor which absorbs at least part of light emitted from the light emission means and thus emits light of a different wavelength, and the light source unit further has a heat radiation means which is in contact with the wavelength conversion means. According to the light source unit, temperature rise of the phosphor can be suppressed by the use of the radiation means in contact with the wavelength conversion means.

### CITATION LIST

### Patent Literature

PTL1Japanese Patent Application Laid-Open No. 2005-294185

### SUMMARY OF INVENTION

### Technical Problem

However, the light source unit described in Patent Document 1 has a problem in that leakage of light occurs and the light utilization efficiency is low.

The objective of the present invention is to provide a light source unit, a projection-type display device, lighting equipment and a light emission method, which are with high light utilization efficiency.

### Solution to Problem

In order to achieve the objective described above, a light source unit of the present invention comprises a light emission means, a wavelength conversion means and a first wavelength selection means, wherein:

the light emission means has a light, emission surface which emits light, of a first wavelength band and also reflects and thus emits light incident on the light emission surface;

the wavelength conversion means has an incidence/emission surface which, when light of the first wavelength band is incident on the light emission surface, emits light of a second wavelength band toward the same side as that of the incidence of the light of the first wavelength band, and also reflects and thus emits light of the second wavelength band incident on the light emission surface;

the first Wavelength, selection means has a first reflection surface which reflects light of the first wavelength band and transmits light of the second wavelength band; and

the light emission means and the first wavelength selection means are arranged such that light of the first wavelength band emitted from the light emission surface of the light emission means, light of the first wavelength band reflected by the first reflection surface of the first wavelength selection means and light of the first wavelength band incident on and then reflected by the light emission surface of the light emission means all become incident on the incidence/emission surface of the wavelength conversion means.

Another light source unit of the present invention comprises a light emission means, a wavelength conversion means, a first wavelength selection means and a second wavelength selection means, where:

the light emission means has a light emission surface which emits light of a first wavelength band and also reflects and thus emits light incident on the light emission surface;

the wavelength conversion means has an incidence/emission surface which, when light of the first wavelength band is incident on the incidence/emission surface, emits light of a second wavelength band toward the same side as that of the incidence of the light of the first wavelength band, and also reflects and thus emits light of the second wavelength band incident on the incidence/emission surface;

the first wavelength selection means has a first reflection surface which reflects light of the first wavelength band and transmits light of the second wavelength band:

the second wavelength selection means has a second reflection surface which reflects light of the second wavelength band and transmits light of the first wavelength band; and

the light emission means, the first wavelength selection means and the second wavelength selection means are arranged such that light of the first wavelength band emitted from the light emission surface of the light emission means, light of the first wavelength band reflected by the first reflection surface of the first wavelength selection means, light of the first wavelength band having transmitted the second reflection surface of the second wavelength selection means and light of the first wavelength band incident on and then reflected by the light emission surface of the light emission means all become incident on the incidence/emission surface of the wavelength conversion means.

A projection-type display device of the present invention includes the light source units of the present invention described above.

Lighting equipment of the present invention includes the light source units of the present invention described above.

A light emission method of the present invention uses a light source unit comprising a light emission means, a wavelength conversion means and a first wavelength selection means, wherein:

the light emission means has a light emission surface which emits light of a first wavelength band and also reflects and thus emits light incident on the light emission surface;

the wavelength conversion means has an incidence/emission surface which, when light of the first wavelength band is incident on the incidence/emission surface, emits light of a second wavelength band toward the same side as that of the incidence of the light of the first wavelength band, and also reflects and thus emits light of the second wavelength band incident on the incidence/emission surface; and

the first wavelength selection means has a first reflection surface which reflects light of the first wavelength band and transmits light of the second wavelength band, and

the light emission method of the present invention comprises:

a first light emission process of emitting light of the first wavelength band from the light emission surface of the light emission means;

a first reflection process of reflecting, by the first reflection surface of the first wavelength selection means, light of the first wavelength band emitted from the light emission surface of the light emission means and then incident on the first reflection surface of the first wavelength selection means;

a second reflection process of reflecting, by the light emission surface of the light emission means, light of the first wavelength band reflected by the first reflection surface of the first wavelength selection means and then re-incident on the light emission surface of the light emission means;

a second light emission process of performing wavelength conversion on light incident on the incidence/emission surface of the wavelength conversion means including that emitted from the light emission surface of the light emission means, that reflected by the first reflection surface of the first wavelength selection means and that reflected by the light emission surface of the light emission means, and thereby emitting light of the second wavelength band from the incidence/emission surface of the wavelength conversion means as reflected light;

a third reflection process of reflecting, by the light emission surface of the light emission means, light of the second wavelength band incident on the light emission surface of the light emission means:

a fourth reflection process of reflecting, by the incidence/emission surface of the wavelength conversion means, light of the second wavelength band re-incident on the incidence/emission surface of the wavelength conversion means; and

a third light emission process of emitting light of the second wavelength band emitted from the incidence/emission surface of the wavelength conversion means, light of the second wavelength band reflected by the light emission surface of the light emission means and light of the second wavelength band reflected by the incidence/emission surface of the wavelength conversion means, each of the light of the second wavelength band being incident on the first wavelength selection means, from a side of the first wavelength selection means which is opposite to the side of incidence of light of the first wavelength band on the first wavelength selection means.

### Advantageous Effects of Invention

According to the present invention, it is possible to provide a light source unit, a projection-type display device, lighting equipment and light emission method, which are with high utilization efficiency of light.

### BRIEF DESCRIPTION OF DRAWINGS

FIG. 1 is a perspective view showing a light source unit of an exemplary embodiment 1.

FIG. 2 is a cross-sectional view showing the light source unit of the exemplary embodiment 1.

FIG. 3 is a perspective view showing a light source unit of an exemplary embodiment 2.

FIG. 4 is a cross-sectional view showing the light source unit of the exemplary embodiment 2.

FIG. 5 is a cross-sectional view showing a light source unit of an exemplary embodiment 3.

FIG. 6 is a cross-sectional view showing a light source unit of an exemplary embodiment 4.

FIG. 7 is a perspective view showing a light source unit of an exemplary embodiment 5.

FIG. 8 is a cross-sectional view of the light source unit of the exemplary embodiment 5 shown in Fig, 7, viewed into the 1-1 direction.

FIG. 9 is a cross-sectional view showing a light source unit of an exemplary embodiment 6.

FIG. 10 is a cross-sectional view showing a light source unit of an exemplary embodiment 7.

FIG. 11 is a cross-sectional view showing a light source unit of an exemplary embodiment 8.

FIG. 12 is a cross-sectional view showing a light source unit of an exemplary embodiment 9.

FIG. 13 is a cross-sectional view showing a light source unit of an exemplary embodiment 10.

FIG. 14 is a cross-sectional view showing a light source unit of an exemplary embodiment 11.

FIG. 15 is a cross-sectional view showing a light source unit of an exemplary embodiment 12.

FIG. 16 is a cross-sectional view showing a light source unit of an exemplary embodiment 13.

FIG. 17 is a cross-sectional view showing a light source unit of an exemplary embodiment 14.

### DESCRIPTION OF EMBODIMENTS

Hereinafter, light source units of the present invention will be described in detail, citing examples. However, the present invention is not limited to the following exemplary embodiments. In the following drawings, the same reference sign will be given to the same element. Also in the drawings, for convenience in description, the structure of each element may be illustrated in a properly simplified manner, and the size ratio or the like of each element may be different from the actual one.

### Exemplary Embodiment 1

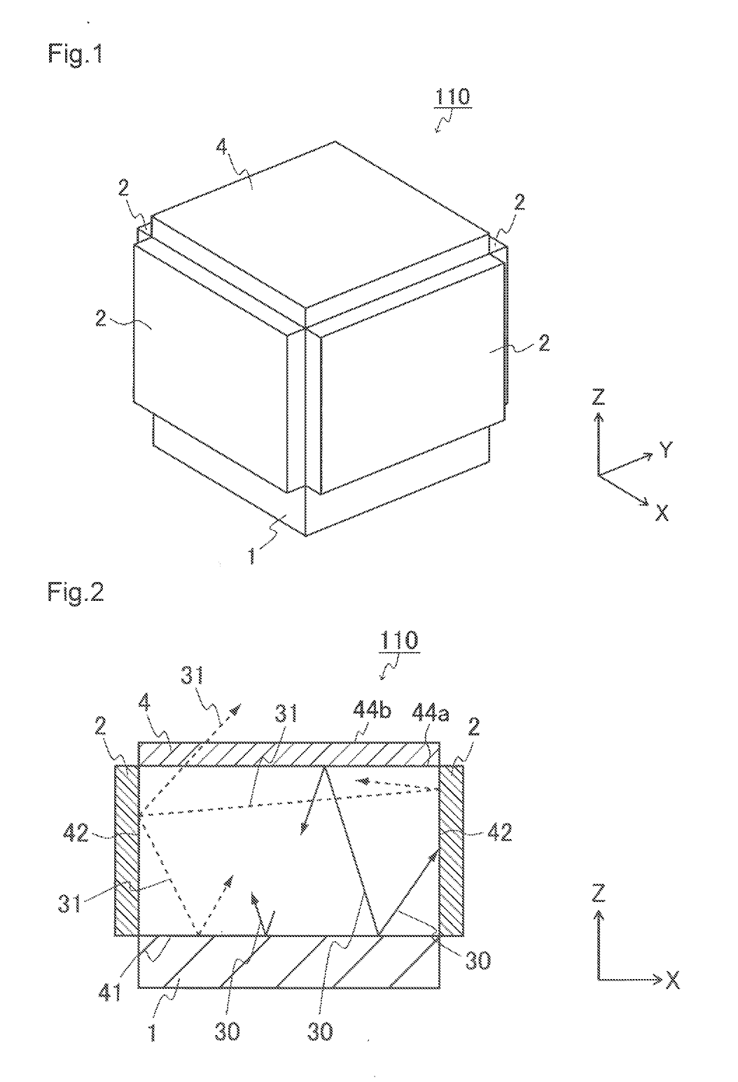

FIG. 1 is a perspective view showing a light source unit of the present exemplary embodiment. FIG. 2 is a cross-sectional view showing the light source unit of the present exemplary embodiment. As shown in FIGS. 1 and 2, the light source unit 110 of the present exemplary embodiment includes a light emission means 1, four wavelength conversion means 2 and a first wavelength selection means 4, as primary constituent elements. In this example, the light emission means 1, the four wavelength conversion means 2 and the first wavelength selection means 4 each have a rectangular cross-sectional shape. The light source unit 110 of the present exemplary embodiment has an internal space, the internal shape of the internal space is columnar, a light emission surface 41 of the light emission means 1 is arranged at the base of the internal shape, a first reflection surface 44a of the first wavelength selection means 4 is arranged at the top surface of the internal shape, and every side surface of the internal shape is an incidence/emission surface 42 of the wavelength conversion means 2. In the present invention, there is no restriction on orientation of a light source unit, and, for example, the light source unit shown in FIGS. 1 and 2 may be turned upside down (may have the light emission means 1 at the top and the first wavelength selection means 4 at the bottom), or may be rotated by 90 degrees (may have the light emission means 1 and the first wavelength selection means 4 arranged at the laterals). This applies also to exemplary embodiments 2 to 14 which will be described later. For convenience, it is assumed, in the present invention, that the light emission surface 41 of the light emission means 1 is described to be the base, and the first reflection surface 44a of the first wavelength selection means 4 to be the top surface.

The light emission means 1 has the light emission surface 41 which emits light of a first wavelength band 30 and also reflects light incident on it and thus emits the reflected light. As the light emission means 1, a surface-emitting solid state light source, such as an LED and an LD, or a surface light-emitting device including a light source and a light guiding plate may be used, for example. Light of the first wavelength band 30 may be set to be, for example, of a wavelength band of a desired color (red, green, blue or the like, for example), and preferably, it is set to be of a blue wavelength band.

The wavelength conversion means 2 has the incidence/emission surface 42 which, when light of the first wavelength band 30 is incident on it, emits light of a second wavelength band 31 toward the same side as the side of the incidence of the light of the first wavelength band 30, and also reflects light of the second wavelength band 31 incident on it and thus emits the reflected light. Light of the second wavelength band 31 may be any light of a wavelength band different from the first wavelength band of the light 30, and preferably, it is set to be of a green wavelength band. It is preferable that the wavelength conversion means 2 includes a phosphor which absorbs light of the first wavelength band 30 and emits light of the second wavelength band 31. The wavelength conversion means 2 can be produced, for example, by fixing the phosphor to the wavelength conversion means 2 using a binder of resin or the like. As examples of a material for the phosphor, following inorganic phosphor materials are mentioned: aluminum garnet-based phosphors such as yttrium aluminum garnet-based phosphors including YAlO₃:Ce, Y₃Al₅O₁₂:Ce: Y₄Al₂O₉:Ce, (Y_{0.8}Gd_{0.2})₃Al₅O₁₂:Ce, Y₃(Al_{0.8}Ga_{0.2})₅O₁₂:Ce, Tb_{2.95}Ce_{0.05}Al₅O₁₂, Y_{2.90}Ce_{0.05}Tb_{0.05}Al_{O}₁₂, Y_{2.94}Ce_{0.05}Pr_{0.01}Al₅O₁₂, Y_{2.90}Ce_{0.05}Pr_{0.05}Al₅O₁₂, (Re₁₋ₓ, Smₓ)₃(Al_{1-y}Ga_{y})₅O₁₂:Ce (Re: at least one element selected from a group consisting of Y, Gd and La, 0x≦<1, 0≦y<1), and the like; lutetium aluminum garnet-based phosphors such as (Lu_{1-a-b}RₐM_{b})₃(Al_{1-c}Ga_{c})₅O₁₂ (R: at least one rare earth element mandatorily including Ce, M: at least one element selected from a group consisting of Sc, Y, La and Gd, 0.0001≦a≦0.5, 0≦b≦0.5, 0.0001≦a+b ≦1, 0≦c≦0.8): nitride-based phosphors including Sr₂Si₅N₈:Eu,Pr, Ba₂Si₅N₈;Eu,Pr, Mg₂Si₅N₈:Eu,Pr, Zn₂Si₅N₈:Eu,Pr, SrSi₇N₁₀Eu,Pr, BaSi₇N₁₀:Eu,Ce, MgSi₇N₁₀:Eu,Ce, ZnSi₇N₁₀:Eu,Ce. Sr₂Ge₅N₈:Eu,Ce, Ba₂Ge₅N₈:Eu,Pr, Mg₂Ge₅N₈:Eu,Pr, Zn₂Ge₅N₈:Eu,Pr, SrGe₇N₁₀:Eu,Ce, BaGe₇N₁₀:Eu,Pr, MgGe₇N₁₀:Eu,Pr, ZnGe₇N₁₀:EuCe, Sr_{1.8}Ca_{0.2}Si₅N₈:Eu,Pr, Ba_{1.8}Ca_{0.2}Si₅N₈:Eu,Ce, Mg_{1.8}Ca_{0.2}Si₅N₈:Eu,Pr, Zn_{1.8}Ca_{0.2}Si₅N₈:Eu,Ce, Sr_{0.8}Ca_{0.2}Si₇N₁₀:Eu,La, Ba_{0.8}Ca_{0.2}Si₇N₁₀:Eu,La, Mg_{0.8}Ca_{0.2}Si₇N₁₀:Eu,Nd, Zn_{0.8}Ca_{0.2}Si₇N₁₀:Eu,Nd, Sr_{0.8}Ca_{0.2}Ge₇N₁₀:Eu,Tb, Ba_{0.8}Ca_{0.2}Ge₇N₁₀Eu,Tb, Mg_{0.8}Ca_{0.2}Ge₇N₁₀:Eu,Pr, Zn_{0.8}Ca_{0.2}Ge₇N₁₀:Eu,Pr, Sr_{0.8}Ca_{0.2}Si₆GeN₁₀:Eu,Pr, Ba_{0.8}Ca_{0.2}Si₆GeN₁₀:Eu,Pr, Mg_{0.8}Ca_{0.2}Si₆GeN₁₀:Eu,Y,Zn_{0.8}Ca_{0.2}Si₆GeN₁₀:Eu,Y, Sr₂Si₅N₈:Pr, Ba₂Si₅N₈:Pr, Sr₂Si₅N₈:Tb, BaGe₇N₁₀:Ce, and the like; oxynitride-based phosphors such as LₓM_{y}O_{z}N_{((2/3)x+(4/3)y-(2/3)z)}:R (L: at least one element selected from a group consisting of Be, Mg, Ca, Sr, Ba and Zn; M: at least one element selected from a group consisting of C, Si, Ge. Sn, Ti, Zr and Hf; R: rare earth element; x, y and z satisfy x=2, 4.5≦y≦6 and 0.01 <z<1.5, or x−1, 6.5≦y≦7.5 and 0.01<z<1.5, or x=1, 1.5≦y≦2.5 and 1.5≦z≦2.5); alkaline-earth metal silicate phosphors including (2-x-y )SrO*x(Ba,Ca)O*(1-a-b-c-d)SiO₂*aP₂O₅bAl₂O₃cB₂O₃dGeO₂:yEu²⁺(0x<1.6, 0.005y<0.5, 0<a, b, c, d<0.5), (2-x-y) BaO*x (Sr,Ca)O*(1-a-b-c-d) SiO₂*aP₂O₅bAl₂O₃cB₂O₃dGeO₂:yEu²⁺(0.01<x<1.6, 0.005<y<0.5, 0<a, b, c, d<0.5) and the like; alkaline-earth metal halogen apatite phosphors including M₅(PO₄)₃(Cl,Br):Eu (M: at least one element selected from a group consisting of Sr, Ca, Ba and Mg), Ca₁₀(PO₄)₆ClBr: Mn,Eu and the like; alkaline-earth metal aluminate-based phosphors including BaMg₂Al₁₆O₂₇:Eu, BaMg₂Al₁₆O₂₇:Eu,Mn, SrAl₁₄O₂₅:Eu, SrAl₂O₄:Eu, CaAl₂O₄:Eu, BaMg₂Al₁₀O₁₇:Eu, BaMgAl₁₀O₁₇:Eu,Mn and the like; rare earth oxysulphide phosphors including La₂O₂S:Eu, Y₂O₂S:Eu, Gd₂O₂S:Eu and the like. Materials used as the phosphor are not limited to the above-mentioned inorganic phosphors, but organic phosphors, semiconductor quantum dot phosphors and the like, for example, may also be used. For the phosphor, one material may be solely used, and two or more materials may also be used in combination.

The first wavelength selection means 4 has the first reflection surface 44a which reflects light of the first wavelength band 30 and transmits light of the second wavelength band 31, and also has the first emission surface 44b which is located on a side opposite to that of the first reflection surface 44a and transmits light of the second wavelength band 31 and thus emits the transmitted light. As the first wavelength selection means 4. for example, one using a dielectric multilayer film, a holographic element, a photonic crystal or the like, which thus has characteristics of transmitting light of a specific wavelength band and reflecting light of any other wavelength band, may be used.

As shown in FIG. 2, the light source unit 110 of the present exemplary embodiment has an internal space. The internal shape of the internal space is quadratic prismatic (rectangular parallelepiped-like). The light emission surface 41 of the light emission means 1 is arranged at the base of the internal shape. The first reflection surface 44a of the first wavelength selection means 4 is arranged at the top surface of the internal shape. The incidence/emission surface 42 of each of the four wavelength conversion means 2 is arranged at a side surface of the internal shape. In this way, the light, emission means 1 and the first wavelength selection means 4 are arranged, in the light, source unit 110, such that light of the first wavelength band 30 emitted from the light emission surface 41 of the light emission means 1, light of the first wavelength band 30 reflected by the first reflection surface 44a of the first wavelength selection means 4 and light of the first wavelength band 30 incident on and then reflected by the light emission surface 41 of the light emission means 1 all become incident on the incidence/emission surface 42 of the wavelength conversion means 2.

Next, a description will be given of a light emission method which uses the light source unit 110 of the present exemplary embodiment, with reference to FIG. 2.

First, the light emission surface 41 of the light emission means 1 emits light of the first wavelength band 30 (first light emission process).

Light of the first wavelength band 30 which is emitted from the light emission surface 41 of the light emission means 1 and then become incident on the first reflection surface 44a of the first wavelength selection means 4 is reflected by the first reflection surface 44a of the first wavelength selection means 4 (first reflection process).

Light of the first wavelength band 30 which is reflected by the first reflection surface 44a of the first wavelength selection means 4 and then become re-incident on the light emission surface 41 of the light emission means 1 is reflected by the light emission surface 41 of the light emission means 1 (second reflection process).

The wavelength conversion means 2 performs wavelength conversion on light of the first wavelength band 30 incident on the incidence/emission surface 42 including that emitted from the light emission surface 41 of the light emission means 1, that reflected by the first reflection surface 44a of the first wavelength selection means 4 and that reflected by the light emission surface 41 of the light emission means 1, and thereby emits light of the second wavelength band 31 from the incidence/emission surface 42 of the wavelength conversion means 2 as reflected light (second light emission process).

Light of the second wavelength band 31 incident on the light, emission surface 41 of the light emission means 1 is reflected by the light emission surface 41 of the light emission means 1 (third reflection process).

Light of the second wavelength band 31 re-incident on the incidence/emission surface 42 of the wavelength conversion means 2 is reflected by the incidence/emission surface 42 of the wavelength conversion means 2 (fourth reflection process).

Light of the second wavelength band 31 incident on the first wavelength selection means 4 including that emitted from the incidence/emission surface 42 of the wavelength conversion means 2, that reflected by the light emission surface 41 of the light emission means 1 and that reflected by the incidence/emission surface 42 of the wavelength conversion means 2 is emitted from the first emission surface 44b of the first wavelength selection means 4, which is located on a side of the first wavelength selection means 4 opposite to the side of the incidence of the light of the second wavelength band 31 (third light emission process).

In the light emission method using the light source unit 110 of the present exemplary embodiment, there is no restriction on the execution sequence of the processes except for the first and the third light emission processes, and some of the processes may be executed simultaneously.

According to the light source unit 110 of the present exemplary embodiment, it is possible to cause light of the first wavelength band 30 emitted from the light emission surface 41 of the light emission means I and then incident on the first reflection surface 44a of the first wavelength selection means 4 to be reflected by the first reflection surface 44a of the first wavelength selection means 4, subsequently become incident on the incidence/emission surface 42 of the wavelength conversion means 2 and thereby be wavelength-converted into light of the second wavelength band 31, and as a result, the light utilization efficiency is increased. Also according to the light source unit 110 of the present exemplary embodiment, it is possible to cause light of the second wavelength band 31 incident on the light emission surface 41 of the light emission means 1 and light of the second wavelength band 31 re-incident on the incidence/emission surface 42 of the wavelength conversion means 2 to be reflected by the respective ones of the surfaces 41 and 42, and subsequently emitted thoroughly from the first emission surface 44b of the first wavelength selection means 4.

Further, according to the light source unit 110 of the present exemplary embodiment, the light utilization efficiency becomes high, and accordingly, the output of the light emission means 1 can be set to be lower. As a result, wavelength conversion of light of the first wavelength band 30 into light of the second wavelength band 31 can be performed, while suppressing temperature rise of the wavelength conversion means 2 and without causing thermal quenching of the phosphor.

In the light source unit 110 shown in FIGS. 1 and 2, the first reflection surface 44a and the first emission surface 44b, of the first wavelength selection means 4, each have the same area as that of the light emission surface 41 of the light emission means 1. However, the present invention is not limited to that case. In the present invention, the first reflection surface 44a and the first emission surface 44b, of the first wavelength selection means 4, each may have an area either being smaller than or exceeding the area of the light emission surface 41 of the light emission means 1. In the present invention, it is preferable that the first reflection surface 44a and the first emission surface 44b, of the first wavelength selection means 4, each have an area equal to or smaller than that of the light emission surface 41 of the light emission means 1. By thus setting, the etendue of light of the second wavelength band 31 emitted from the first emission surface 44b of the first wavelength selection means 4 can be set to be equal to or smaller than the etendue of light of the first wavelength band 30 emitted from the light emission surface 41 of the light emission means 1. Here, the etendue is calculated by (emission area)×(emission angle).

When applying the light source unit 110 of the present exemplary embodiment to a projector, for example, the light utilization efficiency of the optical system of the projector improves with decreasing the etendue of the light source unit 110. Therefore, decrease in the light utilization efficiency of the optical system of the projector can be suppressed by setting the etendue of the light source unit 110 (the etendue of light of the second wavelength band 31 emitted from the first emission surface 44b of the first wavelength selection means 4) to be equal to or smaller than the etendue of light of the first wavelength band 30 emitted from the light emission surface 41 of the light emission means 1.

In the light source unit 110 shown in FIGS. 1 and 2, the transmittance of the wavelength conversion means 2 may be reduced, in order to suppress transmission of light of the first wavelength band 30 and light of the second wavelength band 31 through the wavelength conversion means 2, by increasing the concentration of the phosphor material in the wavelength conversion means 2, mixing a scattering material into the wavelength conversion means 2, increasing the thickness of the wavelength conversion means 2 and the like. A reflection layer having a characteristic of reflecting light of the first wavelength band 30 and light of the second wavelength band 31 may be arranged on a surface of the wavelength conversion means 2 opposite to the incidence/emission surface 42. In this way, it becomes possible, in the light source unit 110, to reduce the amount of light passing through the wavelength conversion means 2 and accordingly increase the amount of light of the second wavelength band 31 emitted from the first emission surface 44b of the first wavelength selection means 4, that is, to improve the emission efficiency of the light source unit 110. As examples of a material for forming the reflection layer, alumina, silver, white-colored silicone resin, barium sulfate and the like are mentioned. A dielectric multilayer film or the like may also be used for the reflection layer, for example.

In the light source unit 110 shown in FIGS. 1 and 2, light of the first wavelength band 30 incident on the light emission surface 41 of the light emission means 1 is partly absorbed by the light emission means 1. In order to suppress the absorption, the length of the wavelength conversion means 2 may be elongated in the z-direction in FIGS. 1 and 2. This enables reduction of the amount of light of the first wavelength band 30 incident on the light emission surface 41 of the light emission means 1.

In the light source unit 110 shown in FIGS. 1 and 2, the shapes of the light emission means 1. the four wavelength conversion means 2 and the first wavelength selection means 4 are all rectangular, and the internal shape of the internal space of the light source unit 110 is quadratic prismatic (rectangular parallelepiped-like). However, the light source unit of the present exemplary embodiment is not limited to that case. In the light source unit of the present exemplary embodiment, what is mandatorily required for the internal shape of the internal space is to be a prismatic/columnar one having the light emission surface of the light emission means and the first reflection surface of the first wavelength selection means arranged at its base and top surface, respectively, and therefore, the internal shape may be set to be an optional prismatic/columnar shape such as cylindrical, triangular prismatic, cubic and n-angular prismatic (n: integer equal to or larger than 5) ones, by changing the shapes of the light emission means and the first wavelength selection means and also by changing the number and shape of the wavelength conversion means.

In the light source unit 110 shown in FIGS. 1 and 2, the first reflection surface 44a and the first emission surface 44b, of the first wavelength selection means 4. are each arranged on the opposite side of the other one, in the first wavelength selection means 4. However, the present invention is not limited to this example, and accordingly, in the first wavelength selection means, the first reflection surface may be arranged at the same surface as that of the first emission surface, and the first emission surface may accordingly double as the first reflection surface, for example.

### Exemplary Embodiment 2

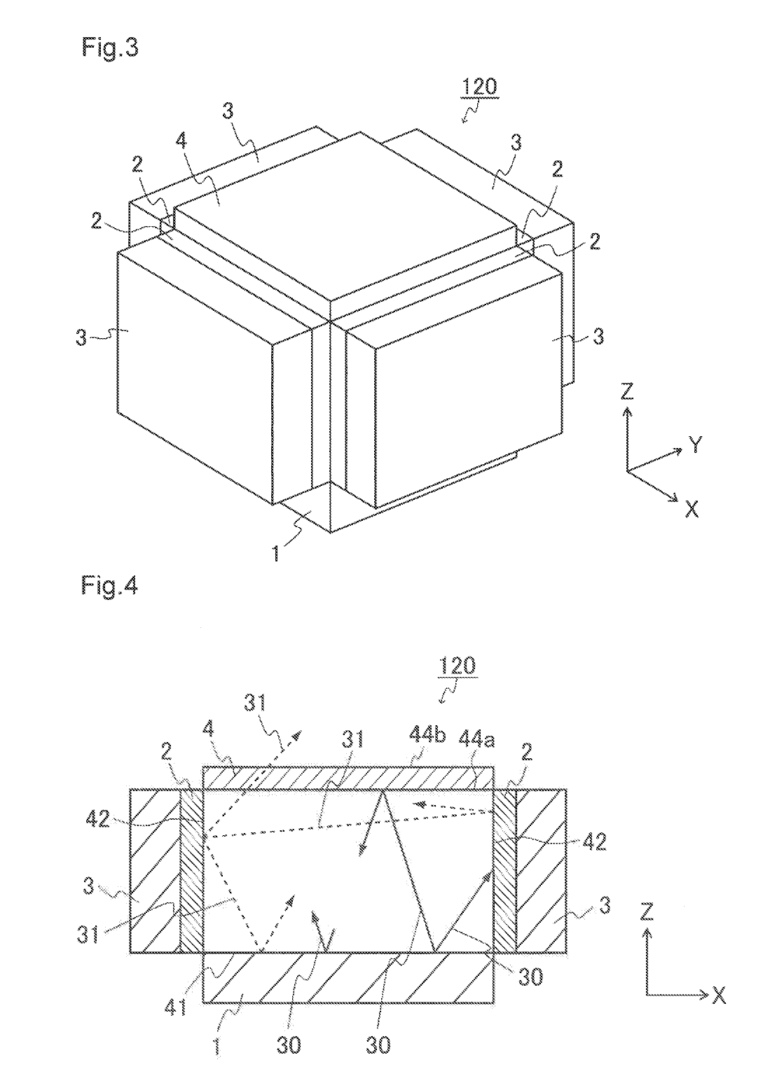

FIG. 3 is a perspective view showing a light source unit of the present exemplary embodiment. FIG. 4 is a cross-sectional view showing the light source unit of the present exemplary embodiment. The light source unit 120 of the present exemplary embodiment is equivalent to the light source unit 110 of the exemplary embodiment 1 shown in FIGS. 1 and 2 further comprising four heat radiation means 3. As shown in FIGS. 3 and 4, the light source unit 120 of the present exemplary embodiment is of the same configuration as that of the light source unit 110 of the exemplary embodiment 1 shown in FIGS. 1 and 2, except that the light source unit 120 has the four heat radiation means 3 which are each arranged on a surface of the corresponding one of the four wavelength conversion means 2 which is opposite to the incidence/emission surface 42 of the wavelength conversion means 2.

As a material for forming the heat radiation means 3, a material with high thermal conductivity is preferable, and copper, aluminum and the like may be used, for example. The heat radiation means 3 may be connected with a heat sink, a heat pipe or the like.

According to the light source unit 120 of the present exemplary embodiment, it is possible to further suppress temperature rise of the wavelength conversion means 2 and more efficiently perform wavelength conversion of light of the first wavelength band 30 into light of the second wavelength band 31, because the heat radiation means 3 are in contact with the respective wavelength conversion means 2 over a wide area.

In the light source unit 120 of the present exemplary embodiment, in order to suppress transmission of the light of the first wavelength band 30 and light of the second wavelength band 31 through the wavelength conversion means 2 and their subsequent absorption by the heat radiation means 3, the transmittance of the wavelength conversion means 2 may be reduced, similarly to in the light source unit 110 of the exemplary embodiment 1, by increasing the concentration of the phosphor material in the wavelength conversion, means 2, mixing a scattering material into the wavelength conversion means 2, increasing the thickness of the wavelength conversion means 2 and the like. Further, in order to suppress absorption of light of the first wavelength band 30 and light of the second wavelength band 31 by the heat radiation means 3, a reflection layer having a characteristic of reflecting light of the first wavelength band 30 and light of the second wavelength band 31 may be arranged between the wavelength conversion means 2 and the respective heat radiation means 3. In this way, it becomes possible, in the light source unit 110, to reduce light absorption loss caused by the heat radiation means 3 and accordingly increase the amount of light of the second wavelength band 31 emitted from the first emission surface 44b of the first wavelength selection means 4, that is, to improve the emission efficiency of the light source unit 110. As examples of a material for forming the reflection layer, alumina, silver, white-colored silicone resin, barium sulfate and the like are mentioned. A dielectric multilayer film or the like may also be used for the reflection layer, for example.

### Exemplary Embodiment 3

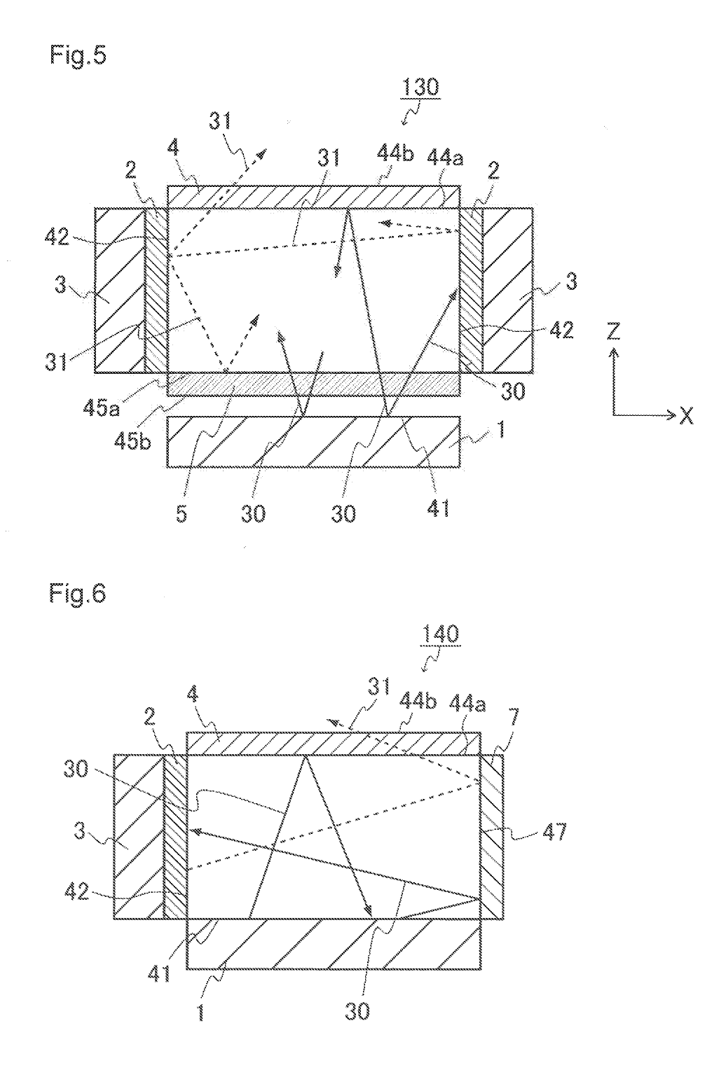

FIG. 5 is a cross-sectional view showing a light source unit of the present exemplary embodiment. The light source unit 130 of the present exemplary embodiment is equivalent to the light source unit 120 of the exemplary embodiment 2 shown in FIGS. 3 and 4 further comprising a second wavelength selection means 5. As shown in FIG. 5, the light source unit 130 of the present exemplary embodiment is of the same configuration as that of the light source unit 120 of the exemplary embodiment 2 shown in FIGS. 3 and 4, except that it further comprises the second wavelength selection means 5 arranged above the light emission surface 41 of the light emission means 1. Here, in the light source unit 130 of the present exemplary embodiment, the beat radiation means 3 is an optional constituent member and accordingly does not necessarily to be included, but it is preferably included; which, is also the case for an exemplary embodiment 4 and subsequent examples.

The second wavelength selection means 5 has a second reflection surface 45a which reflects light of the second wavelength band 31 and transmits light of the first wavelength band 30, and has a second emission surface 45b, on the opposite side of the second reflection surface 45a (on the side of the light emission means 1 in FIG. 5), which transmits and thus emits light of the first wavelength band 30. Accordingly, the second wavelength selection means 5 transmits light of the first wavelength band 30 and reflects light of the second wavelength band 31. As the second wavelength selection means 5. a dielectric multilayer film or the like may be used, for example. In the light source unit 130 shown in FIG. 5. the second reflection surface 45a and the second emission surface 45b, of the second wavelength selection means 5. are each arranged on the opposite side of the other one, in the second wavelength selection means 5. However, the present invention is not limited to this example, and accordingly, in the second wavelength selection means, the second reflection surface may be arranged at the same surface as that of the second emission surface, and the second emission surface may accordingly double as the second reflection surface, for example.

In the light source unit 130 of the present exemplary embodiment, light of the second wavelength band 31 becoming incident on the light emission surface 41 of the light emission means 1 is reflected by the second wavelength selection means 5. As a result, according to the present exemplary embodiment, it is possible to suppress absorption of light of the second wavelength band 31 by the light emission means 1, and accordingly to achieve a light source unit with higher light emission efficiency.

Similarly to the light source unit 130 of the present exemplary embodiment, light source units of exemplary embodiments 4 to 9 and 11 to 13, which will be described later, may include the second wavelength selection means 5.

### Exemplary Embodiment 4

FIG. 6 is a cross-sectional view showing a light source unit, of the present exemplary embodiment. The light source unit 140 of the present exemplary embodiment is equivalent to the light source unit 120 of the exemplary embodiment 2 shown in FIGS. 3 and 4 including a reflection means 7 in place of some of the wavelength conversion means 2 and of the heat radiation means 3. As shown in FIG. 6. the light source unit 140 of the present exemplary embodiment is of the same configuration as that of the light source unit 120 of the exemplary embodiment 2 shown in FIGS. 3 and 4, except that one of the four combinations of the wavelength conversion means 2 and the heat radiation means 3 is replaced by the reflection means 7.

The reflection means 7 has a third reflection surface 47 which reflects light of the first wavelength band 30 and light of the second wavelength band 31. As examples of a material for forming the reflection means 7, alumina, silver, white-colored silicone resin, barium sulfate and the like are mentioned. A dielectric multilayer film or the like may also be used as the reflection means 7, for example.

According to the light source unit 140 of the present exemplary embodiment, the configuration of the light source unit can be simplified and reduced in size by replacing, with the reflection means 7, one of the four combinations of the wavelength conversion means 2 and the heat radiation means 3.

In the light source unit 140 shown in FIG. 6, one of the four combinations of the wavelength conversion means 2 and the heat radiation means 3 has been replaced by the reflection means 7. However, the light source unit of the present exemplary embodiment is not limited to that case. In the light source unit of the present exemplary embodiment, two or three of the four combinations of the wavelength conversion means 2 and the heat radiation means 3 may be replaced by the reflection means 7. As long as at least one wavelength conversion means 2 is equipped, it is possible to perform wavelength conversion of light, of the first wavelength band 30 emitted from the light emission surface 41 of the light emission means 1 into light of the second wavelength band 31 and emit the converted light from the first emission surface 44b of the first wavelength selection means 4.

### Exemplary Embodiment 5

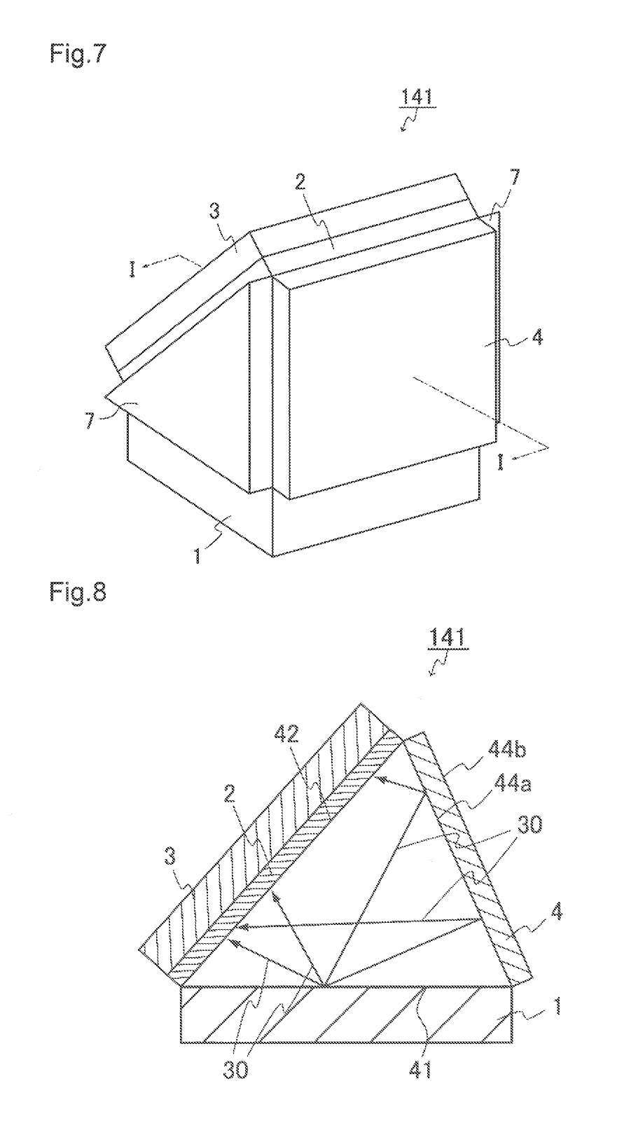

FIG. 7 is a perspective view showing a light source unit of the present exemplary embodiment. FIG. 8 is a cross-sectional view of the light source unit of the present exemplary embodiment shown in FIG. 7, viewed into the I-I direction. The light source unit 141 of the present exemplary embodiment is a light source unit whose cross-sectional shape of the internal space is triangular. As shown in FIGS. 7 and 8, the light source unit 141 of the present exemplary embodiment has an internal space whose cross-sectional shape is triangular, where the light emission surface 41 of the light emission means 1 is arranged to be located at the base of the cross-sectional shape, the incidence/emission surface 42 of the wavelength conversion means 2 and the first reflection surface 44a of the first wavelength selection means 4 are arranged to be located at respective ones of the remaining two sides of the cross-sectional shape, and third reflection surfaces 47 (not illustrated in FIG. 8) of respective ones of two reflection means 7 are located at both end portions of the incidence/emission surface 42 of the wavelength conversion means 2 and that of the first reflection surface 44a of the first wavelength selection means 4, respectively.

According to the light source unit 141 of the present exemplary embodiment, the light emission means 1 and the wavelength conversion means 2 are arranged to face to each other, and accordingly, the amount of light of the first wavelength band 30 incident on the light emission surface 41 of the light emission means 1 is reduced compared to in the light source unit 140 of the exemplary embodiment 4 shown in FIG. 6. As a result, according to the present exemplary embodiment, it is possible to suppress absorption of light of the first wavelength band 30 by the light emission means 1, and accordingly to achieve, a light source unit with higher light emission efficiency.

### Exemplary Embodiment 6

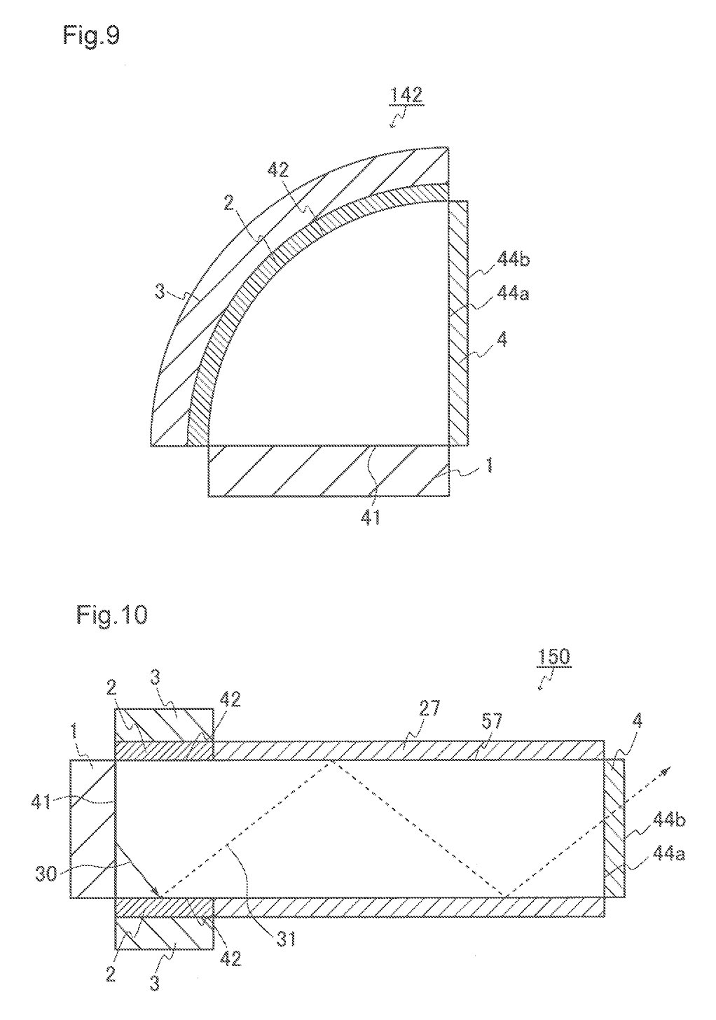

FIG. 9 is a cross-sectional view showing a light source unit of the present exemplary embodiment. The light source unit 142 of the present exemplary embodiment is equivalent to the light source unit 141 of the exemplary embodiment 5 shown in FIGS. 7 and 8 in which the incidence/emission surface 42 of the wavelength conversion means 2 is a curved surface. As shown in FIG. 9, the light source unit 142 of the present exemplary embodiment is of the same configuration as that of the light source unit 141 of the exemplary embodiment 5 shown in FIGS. 7 and 8, except that the incidence/emission surface 42 of the wavelength conversion means 2 is a curved surface.

According to the light source unit 142 of the present exemplary embodiment, the area of the incidence/emission surface 42 can be increased by setting the incidence/emission surface 42 of the wavelength conversion means 2 to be a curved surface. As a result, it becomes possible to reduce the incident amount of light of the first wavelength band 30 per unit area on the incidence/emission surface 42, and accordingly to suppress temperature rise of the wavelength conversion means 2.

### Exemplary Embodiment 7

FIG. 10 is a cross-sectional view showing a light source unit of the present exemplary embodiment. In FIG. 10, a state obtained by rotating FIGS. 1 to 9 by 90 degrees to the right is shown, for convenience, and consequently, the light emission means 1 is located on the left side, and the first wavelength selection means 4 on the right side. The light source unit 150 of the present exemplary embodiment is equivalent to the light source unit 150 of the present exemplary embodiment further including a first light guiding means 27. As shown in FIG. 10, the light, source unit 150 of the present exemplary embodiment is of the same configurations as that of the light source unit 120 of the exemplary embodiment 2 shown in FIGS. 3 and 4, except that it further includes the first light guiding means 27. The first light guiding means 27 is of a tube-like shape similar to the internal side surface shape of the internal space of the light source unit. The first light guiding means 27 has a fourth reflection surface 57 which reflects light of the first wavelength band 30 and light of the second wavelength band 31. In the light source unit 150 of the present exemplary embodiment, the first reflection surface 44a of the first wavelength selection means 4 is arranged, in the internal shape, at the top surface (at the right side surface in FIG. 10) in a manner to have the fourth reflection surface 57 of the first light guiding means 27 in between.

In the light source unit 150 of the present exemplary embodiment, the first light guiding means 27 operates as a light pipe with respect to light of the second wavelength band 31. That is, light of the second wavelength band 31 emitted from the incidence/emission surface 42 of the wavelength conversion means 2 repeats specular reflection by the fourth reflection surface 57 of the first light guiding means 27, and is then emitted from the first emission surface 44b of the first wavelength selection means 4. As a result, light of the second wavelength band 31 emitted from the first emission surface 44b of the first wavelength selection means 4 comes to have more uniform intensity distribution.

Applying the light source unit 150 of the present exemplary embodiment to a projector, for example, when light is projected from the projector to a screen or the like, non-uniformity of illumination intensity on the screen can be suppressed, because of the above-described effect of making uniform the intensity distribution of light of the second wavelength band 31 emitted from the light source unit 150.

### Exemplary Embodiment 8

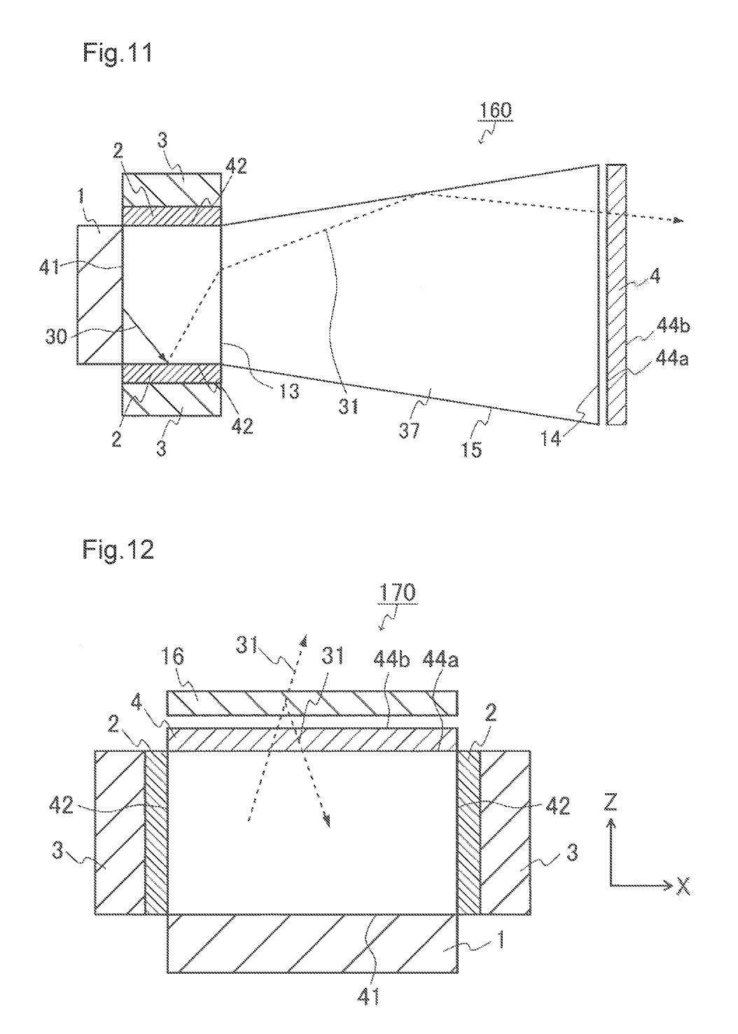

FIG. 11 is a cross-sectional view showing a light source unit of the present exemplary embodiment. In FIG. 11. similarly to in FIG. 10, a state obtained by rotating FIGS. 1 to 9 by 90 degrees to the right is shown, for convenience, and consequently, the light emission means 1 is located on the left side, and the first wavelength selection means 4 on the right side. The light source unit 160 of the present exemplary embodiment is equivalent to the light source unit 120 of the exemplary embodiment 2 shown in FIGS. 3 and 4 further including a second light guiding means 37. As shown in FIG. 11. the light source unit 160 of the present exemplary embodiment is of the same configuration as that of the light source unit 120 of the exemplary embodiment 2 shown in FIGS. 3 and 4, except that it further includes the second light guiding means 37. In the light source unit 160 of the present exemplary embodiment, the first reflection surface 44a of the first wavelength selection means 4 is arranged, in the internal shape of the light source unit, at the top surface (at the right side surface in FIG. 11) in a manner to have the second light guiding means 37 in between. The aperture of the second light guiding means 37 increases along the direction from the light emission surface 41 of the light emission means 1 toward the first reflection surface 44a of the first wavelength selection means 4.

The second light guiding means 37 is formed of a medium capable of transmitting light (glass, resin or the like, for example). The refractive index of the medium is different from that of the atmosphere at the interface (air or the like, for example) which is in contact with the medium. As a result, the interface can reflect light passing through the inside of the medium, and accordingly, a fifth reflection surface 15 which reflects part of incident light is formed on the second light guiding means 37. For example, the fifth, reflection surface 15 of the second light guiding means 37 may be formed by setting the refractive index of the second light guiding means 37 to be higher than that of the surrounding atmosphere (air or the like, for example) and thereby causing part of incident light on the fifth reflection surface 15 to be reflected at the fifth reflection surface 15 by Fresnel reflection or total reflection.

The second light guiding means 37 has an incidence surface 13 on the side of the four wavelength conversion means 2 and an emission surface 14 on the side of the first wavelength selection means 4. The incidence surface 13 and the emission surface 14 transmit light of the first wavelength band 30 and light of the second wavelength band 31. As the incidence surface 13 and the emission surface 14. for example, a configuration for suppressing reflection of light at the interfaces by means of a dielectric multilayer film, a fine structure or the like may be used.

The second light guiding means 37 operates as a rod integrator with respect to light of the second wavelength band 31. That is. light of the second wavelength band 31 emitted from the incidence/emission surface 42 of the wavelength conversion means 2 repeats specular reflection by the fifth reflection surface 15 of the second light guiding means 37, and is then emitted from the first emission surface 44b of the first wavelength selection means 4. As a result, light of the second wavelength band 31 emitted from the first emission surface 44b of the first wavelength selection means 4 comes to have more uniform intensity distribution.

In the light source unit 160 shown in FIG. 11, the aperture of the second light guiding means 37 increases along the direction from the incidence surface 13 toward the emission surface 14. However, the light source unit of the present exemplary embodiment is not limited to that case. In the light source unit of the present exemplary embodiment, the aperture of the second light guiding means may be constant or decreased along the direction from, the incidence surface toward the emission surface. In the light source unit 160 shown in FIG. 11, while the area of the emission surface 14 of the light guiding means 37, and the areas of the first reflection surface 44a and the first emission surface 44b, of the first wavelength selection means 4, become larger than the area of the incidence surface 13 of the second light guiding means 37. the emission angle of light emitted from the first emission surface 44b of the first wavelength selection means 4 becomes smaller than that of incident light on the incidence surface 13 of the second light guiding means 37. This is because the emission angle of light becomes smaller when the light is reflected by the fifth reflection surface 15 of the second light guiding means 37 having a taper. As a result, the etendue in the light source unit 160 does not increase.

Applying the light source unit 160 of the present exemplary embodiment to a projector, for example, when light is projected from the projector to a screen or the like, non-uniformity of illumination intensity on the screen can be suppressed, because of the above-described effect of making uniform the intensity distribution of light of the second wavelength band 31 emitted from the light source unit 160.

As shown in FIG. 11, in the light source unit 160 of the present exemplary embodiment, a small gap (air layer) of about a few hundred urn may exist between the emission surface 14 of the second light guiding means 37 and the first reflection surface 44a of the first wavelength selection means 4. In order to prevent leakage of light, the reflection means described above may be arranged at the both end portions of the gap (top and bottom end portions in FIG. 11).

Alternatively, the emission surface 14 of the second light guiding means 37 and the first reflection surface 44a of the first wavelength selection means 4 may be directly in contact with each other. Further, the emission surface 14 of the second light guiding means 37 may double as the first reflection surface 44a of the first wavelength selection means 4.

In the light source unit 160 shown in FIG. 11. the first wavelength selection means 4 is arranged on the emission surface 14 side of the second light guiding means 37. However, the light source unit of the present exemplary embodiment is not limited to that case. In the light source unit of the present exemplary embodiment, the first wavelength selection means 4 may also be arranged on the incidence surfaces 13 side of the second light guiding means 37. However, when the first wavelength selection means 4 has angular dependence, it is preferable to arrange the first wavelength selection means 4 on the emission surface 14 side of the second light guiding means 37 according to a manner shown in FIG. 11.

### Exemplary Embodiment 9

FIG. 12 is a cross-sectional view showing a light source unit of the present exemplary embodiment. The light source unit 170 of the present exemplary embodiment is equivalent to the light source unit 120 of the exemplary embodiment 2 shown in FIGS. 3 and 4 further including a polarizer 16. As shown in FIG. 12, the light source unit 170 of the present exemplary embodiment is of the same configuration as that of the light source unit 120 of the exemplary embodiment 2 shown in FIGS. 3 and 4, except that if further includes the polarizer 16 arranged on the first emission surface 44b of the first wavelength selection means 4.

The polarizer 16 is a reflective polarizer which has a transmission axis and accordingly transmits light with polarization in a direction parallel to the transmission axis and reflects light with polarization in a direction perpendicular to the transmission axis. As the polarizer 16, a wire grid polarizer, a multilayer film using organic material, and the like may be used, for example.

Out of light of the second wavelength band 31 incident on the polarizer 16, light of the second wavelength band 31 having a polarization component parallel to the transmission, axis passes through the polarizer 16, and light of the second wavelength band 31 having a polarization component perpendicular to the transmission axis is reflected by the polarizer 16. Light of the second wavelength band 31 reflected by the polarizer 16 is returned into the internal space of the light source unit 170, passing through the first wavelength selection means 4. The light 31 having been returned into the internal space becomes incident on the polarizer 16 again, after being reflected a plurality of times within the internal space and consequently having its polarization direction changed. In this way, light of the second wavelength band 31 emitted from the light source unit 170 can be made to be linear polarized light having a polarization component parallel to the transmission axis of the polarizer 16. and the amount of light 31 passing through the polarizer 16 can be increased as a result of the repetition of its reflection between the polarizer 16 and the internal space.

Applying the light source unit 170 of the present exemplary embodiment to, for example, a projector using a liquid crystal display panel as a display element for spatially modulating transmitted light, the light utilization efficiency of the projector can be improved, and the amount of emitted light from the projector can accordingly be increased. A liquid crystal display panel has polarization dependence, so that it spatially modulates only light of a polarization component in a specific direction and does not modulate light of a polarization component in a direction perpendicular to the specific direction. For this reason, light of a polarization component in a direction perpendicular to the specific direction cannot be used in the above-described projector using a liquid crystal display panel. On the other hand, light emitted from the light source unit 170 of the present exemplary embodiment is linear polarized light having a polarization component in a specific direction, and has high rate of light of a polarization component in the specific direction as a result of repeating reflection between the polarizer 16 and the internal space, and therefore, it becomes possible to reduce the amount of light unable to be used in the optical system, such as described above, and accordingly to increase the amount of emitted light from the projector.

The light source units of the exemplary embodiments 1 and 3 to 8 described above and also of exemplary embodiments 10 to 14, which will be described below, may also include the polarizer 16, similarly to the light source unit 170 of the present exemplary embodiment.

Exemplary Embodiment 10

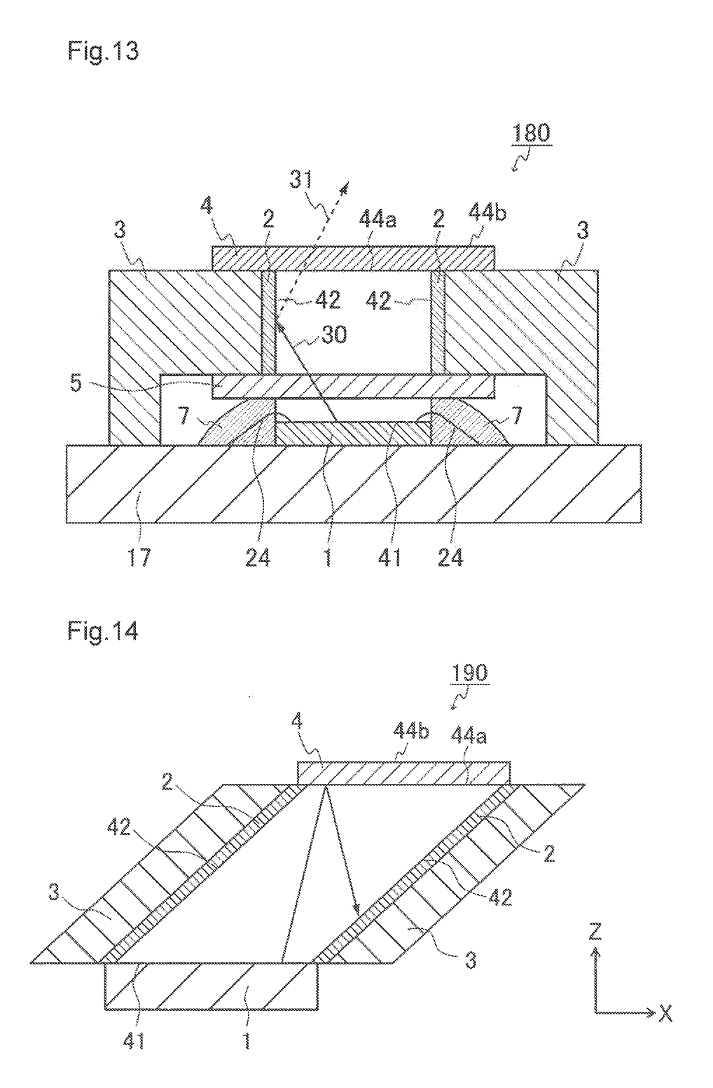

FIG. 13 is a cross-sectional view showing a light source unit of the present exemplary embodiment. The light source unit 180 of the present exemplary embodiment is an example of a light source unit employing an LED as the light emission means 1. As shown in FIG. 13, the light source unit 180 of the present exemplary embodiment includes, as primary constituent members, a substrate 17, the light emission means 1 (an LED, in this example) arranged on the substrate 17, the second wavelength selection means 5 arranged above the light emission surface 41 of the LED 1, the four reflection means 7 arranged between the substrate 17 and the second wavelength selection means 5, the four wavelength conversion means 2 arranged on the opposite side of the LED 1 with reference to the second wavelength selection means 5, four heat radiation means 3 each having an L-shaped cross section and being in contact with the substrate 17 and with a surface of the corresponding one of the four wavelength conversion means 2 opposite to the incidence/emission surface 42, and the first wavelength selection means 4 arranged on top of the four wavelength conversion means 2 and of the four heat radiation means 3.

The substrate 17 is electrically connected with a power supply device not illustrated in the drawing. The LED 1 is electrically connected with the substrate 17 via bonding wires 24.

The reflection means 7 are arranged to surround the LED 1. The reflection means 7 may also have the role of fixing the substrate 17 and the second wavelength selection means 5 to each other.

The substrate 17 and the four heat radiation means 3 are mechanically connected with each other by adhesive or the like. Mechanical connection is also made, by adhesive or the like, between the second wavelength selection means 5 and the four reflection means 7, and between the first wavelength selection means 4 and the four heat radiation means 3. Here, if setting the size of the second wavelength selection means 5 and that of the first wavelength selection means 4 to be larger than enough to seal the portion inside the four wavelength conversion means 2, as shown in FIG. 13, it becomes easy to mechanically connect the second wavelength selection means 5 with the four reflection means 7, and the first wavelength selection means 4 with the four heat radiation means 3, and leakage of light can also be suppressed, and accordingly, the light emission efficiency of the light source unit 180 can be increased further.

It is preferable that the area inside the portion in contact with the four wavelength conversion means 2 of the first reflection surface 44a of the first wavelength selection means 4 is set to be equal to or smaller than the area inside the portion in contact with the four wavelength conversion means 2 of the surface of the second wavelength selection means 5 on the side of the four wavelength conversion means 2.

It is preferable that the area inside the portion in contact with the four wavelength conversion means 2 of the surface of the second wavelength selection means 5 on the side of the four wavelength conversion means 2 is set to be equal to or smaller than the area of the light emission surface 41 of the LED 1.

Next, a light emission method using the light source unit 180 of the present exemplary embodiment will be described.

First, the LED 1 generates light of the first wavelength band 30 in its internal light emitting layer, which is not illustrated, in accordance with a current value supplied from the power supply device, and emits the light from the light, emission surface 41 (first light emission process).

Light of the first wavelength band 30 emitted from the light emission surface 41 of the LED 1 and then incident on the first reflection surface 44a of the first wavelength selection means 4 is reflected by the first reflection surface 44a of the first wavelength selection means 4 (first reflection process).

Light of the first wavelength band 30 reflected by the first reflection surface 44a of the first wavelength selection means 4 and then re-incident on the light emission surface 41 of the LED 1 is reflected by the light emission surface 41 of the LED 1 (second reflection process).

Wavelength conversion is performed on light incident on the incidence/emission surface 42 of the wavelength conversion means 2 including light of the first wavelength band 30 emitted from the light emission surface 41 of the LED 1, light of the first wavelength band 30 reflected by the first reflection surface 44a of the first wavelength selection means 4 and light of the first wavelength band 30 reflected by the light emission surface 41 of the LED 1, and thus generated light of the second wavelength band 31 is emitted from the incidence/emission surface 42 of the wavelength conversion means 2 as reflected light (second light emission process).

Light of the second wavelength band 31 incident on the light emission surface 41 of the LED 1 is reflected by the light emission surface 41 of the LED 1 (third reflection process).

Light of the second wavelength band 31 re-incident on the incidence/emission surface 42 of the wavelength conversion means 2 is reflected by the incidence/emission surface 42 of the wavelength conversion means 2 (fourth reflection process).

Light of the second wavelength band 31 incident on the first wavelength selection means 4 including that emitted from the incidence/emission surface 42 of the wavelength conversion means 2. that reflected by the light emission surface 41 of the LED 1 and that reflected by the incidence/emission surface 42 of the wavelength conversion means 2 is emitted from the first emission surface 44b of the first wavelength selection means 4 located on the side opposite to the side of the incidence of light of the first wavelength band 30 (third light emission process).

In the light emission method using the light source unit 180 of the present exemplary embodiment, there is no restriction on the execution sequence of the processes except for the first and the third light emission processes, and some of the processes may be executed simultaneously.

### Exemplary Embodiment 11

FIG. 14 is a cross-sectional view showing a light source unit of the present exemplary embodiment. The light source unit 190 of the present exemplary embodiment is equivalent to the light source unit 120 of the exemplary embodiment 2 shown in FIGS. 3 and FIG. 4 in which the angles made by some of the wavelength conversion means 2 with the light emission means 1 and with the first wavelength selection means 4 are changed. As shown in FIG. 14, the light source unit 190 of the present exemplary embodiment is of the same configuration as that of the light source unit 120 of the exemplary embodiment 2 shown in FIGS. 3 and 4, except that the angles made by two of the four wavelength conversion means 2 with the light emission means 1 and with the first wavelength selection means 4 are not right angles.

According to the light source unit 190 of the present exemplary embodiment, it is possible to suppress the rate of light of the first wavelength band 30 incident on the light emission means 1, and accordingly to increase the light emission efficiency of the light source unit 190.

### Exemplary Embodiment 12

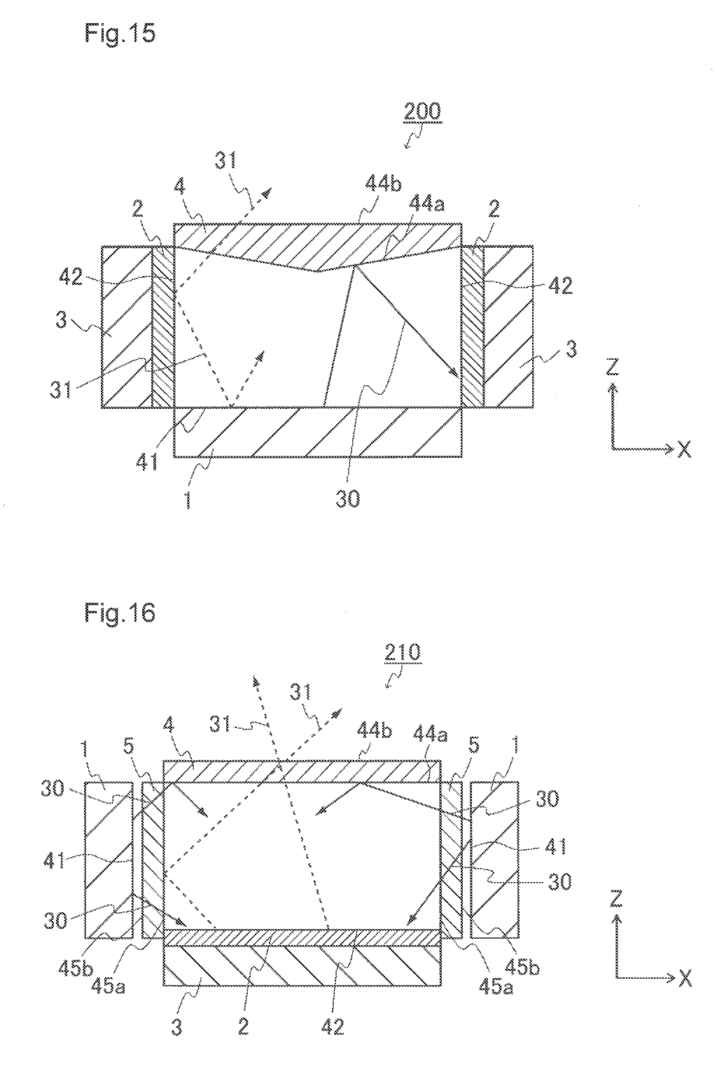

FIG. 15 is a cross-sectional view showing a light source unit of the present exemplary embodiment. The light source unit 200 of the present exemplary embodiment is equivalent to the light source unit 120 of the exemplary embodiment 2 shown in FIGS. 3 and 4 in which the shape of the first wavelength selection means 4 is changed. As shown in FIG. 15, the light source unit 200 of the present exemplary embodiment is of the same configuration as that of the light source unit 120 of the exemplary embodiment 2 shown in FIGS. 3 and 4, except that the first wavelength selection means has a first reflection surface 44a of an upheaved shape.

According to the light source unit 200 of the present exemplary embodiment, it is possible to suppress the rate of light of the first wavelength band 30 incident on the light emission means 1, and accordingly to increase the light emission efficiency of the light source unit 200.

### Exemplary Embodiment 13

FIG. 16 is a cross-sectional view showing a light source unit of the present exemplary embodiment. The light source unit 210 of the present exemplary embodiment is a light source unit comprising a plurality of light emission means 1. As shown in FIG. 16, the light source unit 210 of the present exemplary embodiment has an internal space, and the internal shape of the internal space is quadratic prismatic (rectangular parallelepiped-like). The incidence/emission surface 42 of the wavelength conversion means 2 is arranged at the base of the internal shape. The first reflection surface 44a of the first wavelength selection means 4 is arranged at the top surface of the internal shape. The four second wavelength selection means 5 are each arranged at a side surface of the internal shape, and four light emission means I are arranged just outside respective ones of the four second wavelength selection means 5.

According to the light source unit 210 of the present exemplary embodiment, by thus using a plurality of light emission means 1, it is possible to increase the intensity of light of the first wavelength band 30, and accordingly to further increase the light emission efficiency of the light source unit 210.

### Exemplary Embodiment 14

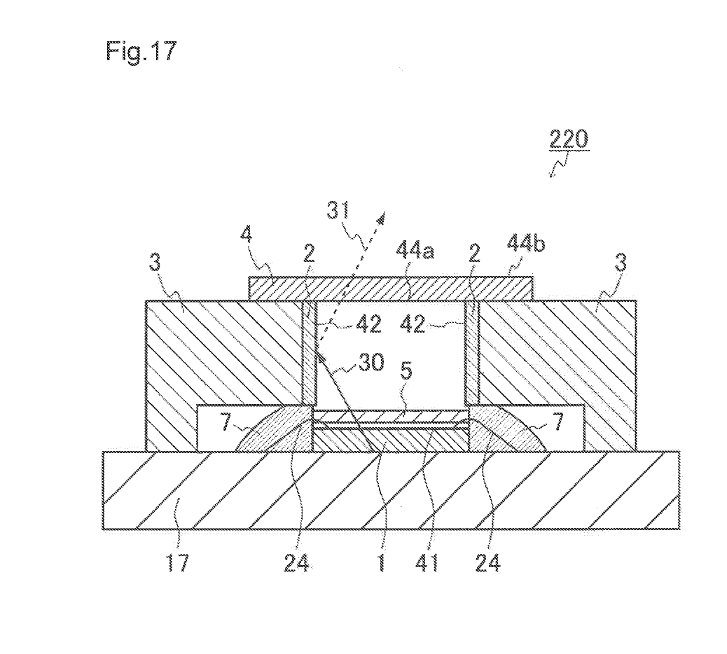

FIG. 17 is a cross-sectional view showing a light source unit of the present exemplary embodiment. The light source unit of the present exemplary embodiment is equivalent to the light source unit 180 of the exemplary embodiment 10 shown in FIG. 13 in which the sizes of the four reflection means 7 are changed. As shown in FIG. 17, the light source unit 220 of the present exemplary embodiment is of the same configuration as that of the light source unit ISO of the exemplary embodiment 10 shown in FIG. 13, except that the second wavelength selection means 5 has a size enabling it to be contained within a space formed by the four reflection means 7

According to the light source unit 220 of the present exemplary embodiment, by arranging the four reflection means 7 each at a side surface of the second wavelength selection means 5, it is possible to further suppress leakage of light, and accordingly to further increase the light emission efficiency of the light source unit 220.

Although the present invention has been described above with reference to the exemplary embodiments, the present invention is not limited to the above-described exemplary embodiments. To the configurations and details of the present invention, various changes which can be understood by those skilled in the art may be made within the scope of the present invention.

This application is based upon and claims the benefit of priority from Japanese Patent Application No. 2012-131836, filed on Jun. 11, 2012, the disclosure of which is incorporated herein in its entirety by reference.

### REFERENCE SIGNS LIST

1 light emission means

2 wavelength conversion means

3 heat radiation means

4 first wavelength selection means

5 second wavelength selection means

7 reflection means

13 incidence surface

14 emission surface

15 fifth reflection surface

16 polarizer

17 substrate

24 bonding wire

27 first light guiding means

30 light of first wavelength band

31 light of second wavelength band

37 second light guiding means

41 light emission surface

42 incidence/emission surface

44a first reflection surface

44b first emission surface

45a second reflection surface

45b second emission surface

47 third reflection surface

57 fourth reflection surface

110, 120, 130, 140, 141, 142, 150. 160, 170, 180, 190, 200, 210, 220 light source unit

1. A light source unit comprising a light emission unit, a wavelength conversion unit and a first wavelength selection unit, wherein:
the light emission unit has a light emission surface which emits light of a first wavelength band and also reflects and thus emits light incident on the light emission surface;
the wavelength conversion unit has an incidence/emission surface which, when light, of the first wavelength band is incident on the incidence/emission surface, emits light of a second wavelength band toward the same side as that of the incidence of the light, of the first wavelength band and also reflects and thus emits light of the second wavelength band incident on the incidence/emission surface;
the first wavelength selection unit has a first reflection surface which reflects light of the first, wavelength band and transmits light of the second wavelength band; and
the light emission unit and the first wavelength selection unit are arranged such that light of the first wavelength band emitted from the light emission surface of the light emission unit, light of the first wavelength band reflected by the first reflection surface of the first wavelength selection unit and light of the first wavelength band incident on and then reflected by the light emission surface of the light emission unit become incident on the incidence/emission surface of the wavelength conversion unit.

2. A light source unit comprising a light emission unit, a wavelength conversion unit, a first wavelength selection unit and a second wavelength selection unit, wherein:
the light emission unit has a light emission surface which emits light of a first wavelength band and also reflects and thus emits light incident on the light emission surface;
the wavelength conversion unit has an incidence/emission surface which, when light, of the first wavelength band is incident on the incidence/emission surface, emits light of a second wavelength band toward the same side as that of the incidence of the light, of the first wavelength band and also reflects and thus emits light of the second wavelength band incident on the incidence/emission surface;
the first wavelength selection unit has a first reflection surface which reflects light of the first wavelength band and transmits light of the second wavelength band;
the second wavelength selection moans unit has a second reflection surface which reflects light of the second wavelength band and transmits light of the first wavelength band; and
the light emission unit, the first wavelength selection unit and the second wavelength selection unit are arranged such that light of. the first wavelength band emitted from the light emission surface of the light emission unit, light of the first wavelength band reflected by the first reflection surface of the first wavelength selection unit, light of the first wavelength band transmitted by the second reflection surface of the second wavelength selection unit and light of the first wavelength band incident on and then reflected by the light, emission surface of the light, emission unit become incident on the incidence/emission surface of the wavelength conversion moons unit.

3. The light, source unit according to claim 1 further comprising a reflection unit, wherein:
the reflection unit has a third reflection surface which reflects light of the first wavelength band and light of the second wavelength band; and
the reflection unit is at least a part of one of three kinds of unit including the light emission unit, the wavelength conversion unit and the first wavelength selection unit or independent unit separated from the three kinds of unit.

4. The light source unit according to claim 1, wherein:
the light source unit has an internal space;
the internal shape of the internal space is columnar;
the light emission surface of the light emission unit is arranged at the base of the internal shape;
the first reflection surface of the first wavelength selection unit is arranged at. the top surface of the internal shape; and
the whole or part of a side surface of the internal shape is the incidence/emission surface of the wavelength conversion unit.

5. The light, source unit according to claim 4 further comprising a reflection unit, wherein part of a side surface of the internal shape is the reflection unit.

6. The light source unit according to claim 3, wherein:
the light source unit has an internal space;
the cross-sectional shape of the internal space is triangular;
the light emission surface of the light emission unit is arranged to be located at the base of the cross-sectional shape;
the incidence/emission surface of the wavelength conversion unit and the first reflection surface of the first wavelength selection unit are arranged to be located at respective ones of the remaining two sides of the cross-sectional shape; and
the third reflection surfaces of respective ones of two aforementioned reflection unit are arranged at both end portions of the incidence/emission surface of the wavelength conversion unit and at those of the first reflection surface of the first wavelength selection unit, respectively.

7. The light source unit according to claim 6, wherein the incidence/emission surface of the wavelength conversion unit is a curved surface.

8. The light source unit according to claim 4 further comprising a first light guiding unit, wherein:
the first light guiding unit has a tube-like shape similar to that of the side surface of the internal shape of the internal space of the light source unit;
the first light guiding unit has a fourth reflection surface which reflects light of the first wavelength band and light of the second wavelength band; and
in the internal shape, the first reflection surface of the first wavelength selection unit is arranged at the top surface in a manner to have the fourth reflection surface of the first light guiding unit in between.

9. The light source unit according to claim 4 further comprising a second light guiding unit, wherein:
the second light guiding unit is formed of a medium capable of transmitting light;
the refractive index of the medium is different from that of atmosphere at the interface which is in contact with the medium;
the interface can reflect light passing through the inside of the medium; and
in the internal shape of the internal space of the light source unit, the first reflection surface of the first wavelength selection unit is arranged at the top surface in a manner to have the second light guiding unit in between.

10. The light source unit according to claim 1, further comprising a heat radiation unit, wherein
the heat radiation unit is arranged on a surface of the wavelength conversion unit which is opposite to the incidence/emission surface of the wavelength conversion means unit.

11. The light source unit according to claim 1, further comprising a polarizer, wherein
the polarizer is arranged on a side of the first wavelength selection unit which is opposite to the side of incidence of light of the first wavelength band.

12. The light source unit according to claim 1, wherein the wavelength conversion unit includes a phosphor.

13. A projection-type display device comprising a light source unit, according to claim 1.

14. Lighting equipment comprising a light source unit according to claim 1.

15. A light emission method using a light source unit, the light source unit comprising a light emission an it, a wavelength conversion unit and a first wavelength selection unit, wherein:
the light emission unit has a light emission surface which emits light of a first wavelength band and also reflects and thus emits light incident on it;
the wavelength conversion unit has an incidence/emission surface which, when light of the first wavelength band is incident on the incidence/emission surface, emits light of a second wavelength band toward the same side as that of the incidence of the light of the first wavelength band and also reflects and thus emits light of the second wavelength band incident on the incidence/emission surface; and
the first wavelength selection unit has a first reflection surface which reflects light of the first wavelength band and transmits light, of the second wavelength band,
the light emission method comprising:
a first light emission process of emitting light of the first wavelength band from the light emission surface of the light emission unit;
a first reflection process of reflecting, by the first reflection surface of the first wavelength selection unit, light of the first wavelength band emitted from the light emission surface of the light emission unit and then incident on the first reflection surface of the first wavelength selection unit;
a second reflection process of reflecting, by the light emission surface of the light emission unit, light of the first wavelength band reflected by the first reflection surface of the first wavelength selection unit and then re-incident on the light emission surface of the light emission unit;
a second light emission process of performing wavelength conversion on light of the first wavelength band incident on the incidence/emission surface of said wavelength conversion unit including that emitted from the light emission surface of the light emission unit, that reflected by the first reflection surface of the first wavelength selection unit and that reflected by the light emission surface of the light emission unit, and emitting the converted light of the second wavelength band from the incidence/emission surface of the wavelength conversion unit as reflected light;
a third reflection process of reflecting light of the second wavelength band incident on the light emission surface of the light emission unit by the light emission surface of the light emission unit;
a fourth reflection process of reflecting light of the second wavelength band re-incident, on the incidence/emission surface of the wavelength conversion unit by the incidence/emission surface of the wavelength conversion unit; and
a third light emission process of emitting light of the second wavelength band incident on the first wavelength selection unit including that emitted from the incidence/emission surface of the wavelength conversion unit, that reflected by the light emission surface of the light emission unit and that reflected by the incidence/emission surface of the wavelength conversion unit, from a side of the first, wavelength selection unit which is opposite to the side of incidence of the light of the first wavelength band.

16. A light source unit comprising a light emission means, a wavelength conversion means and a first wavelength selection means, wherein:
the light emission means has a light emission surface which emits light of a first wavelength band and also reflects and thus emits light incident on the light emission surface;
the wavelength conversion means has an incidence/emission surface which, when light of the first wavelength band is incident on the incidence/emission surface, emits light of a second wavelength band toward the same side as that of the incidence of the light of the first wavelength band and also reflects and thus emits light of the second wavelength band incident on the incidence/emission surface;
the first wavelength selection means has a first reflection surface which reflects light of the first wavelength band and transmits light of the second wavelength band; and
the light emission means and the first wavelength selection means are arranged such that light of the first wavelength band emitted from the light emission surface of the light emission means, light of the first wavelength band reflected by the first reflection surface of the first wavelength selection means and light of the first wavelength band incident on and then reflected by the light emission surface of the light emission means become incident on the incidence/emission surface of the wavelength conversion means.

17. A light source unit comprising a light emission means, a wavelength conversion means, a first wavelength selection means and a second wavelength selection means, wherein:
the light emission means has a light emission surface which emits light of a first wavelength band and also reflects and thus emits light incident on the light emission surface;
the wavelength conversion means has an incidence/emission surface which, when light of the first wavelength band is incident on the incidence/emission surface, emits light of a second wavelength band toward the same side as that of the incidence of the light of the first wavelength band and also reflects and thus emits light of the second wavelength band incident on the incidence/emission surface;
the first wavelength selection means has a first reflection surface which reflects light of the first wavelength band and transmits light of the second wavelength band;
the second wavelength selection means has a second reflection surface which reflects light of the second wavelength band and transmits light of the first wavelength band; and
the light emission means, the first wavelength selection means and the second wavelength selection means are arranged such that light of the first wavelength band emitted from the light emission surface of the light emission means, light of the first wavelength band reflected by the first reflection surface of the first wavelength selection means, light of the first, wavelength band transmitted by the second reflection surface of the second wavelength selection means and light of the first wavelength band incident on and then reflected by the light emission surface of the light emission means become incident on the incidence/emission surface of the wavelength conversion means.

18. The light source unit according to claim 2 further comprising a reflection unit, wherein:
the reflection unit has a third reflection surface which reflects light of the first wavelength band and light of the second wavelength band; and
the reflection unit is at least a part of one of three kinds of unit including the light emission unit, the wavelength conversion unit and the first wavelength selection unit or independent unit separated from the three kinds of unit.
